(19) United States
(12) Patent Application Publication
(10) Pub. No.: US 2007/0260735 A1
(43) Pub. Date: Nov. 8, 2007

(54) Methods for linking performance and availability of information technology (IT) resources to customer satisfaction and reducing the number of support center calls

(75) Inventors: Stig Arne Olsson, Apex, NC (US); R. John Potok, Cary, NC (US); Richard Joseph Sheftic, Essex Junction, VT (US)

Correspondence Address: CAHN & SAMUELS, LLP, 2000 P. STREET, NW, SUITE 200, WASHINGTON, DC, 20036, US

(73) Assignee: International Business Machines Corporation, Armonk, NY (US)

(21) Appl. No.: 11/409,070

(22) Filed: Apr. 24, 2006

(51) Int. Cl. G06F 15/16

(52) U.S. Cl. 709/227

(57) ABSTRACT

A method and system for evaluating a performance of an IT service. A program tool is loaded onto an end-user computer which determines a performance result with respect to a particular service utilized with the end-user computer. The result is compared to at least one threshold and based on the comparison results and a determination of whether various peer group members have also experienced a particular problem, the problem is reported for action to be taken.

### I. FIELD OF THE INVENTION

This invention relates generally to a method of measuring satisfaction of IT service customers. More particularly, the invention relates to a method for linking the performance and availability of at least one IT service to the satisfaction level of the customers to which the services are provided.

### II. BACKGROUND OF THE INVENTION

In the IT services industry, customer satisfaction is often a key indicator of return on investment (ROI) from the customer's perspective. Further, the customer's level of satisfaction is viewed as a competitive differentiator by the service providers themselves. For providers of IT services, such as IBM, customer satisfaction measurements are often used to identify referenceable clients, drive delivery excellence, identify and resolve pervasive issues, and turn ‘at risk’ accounts and clients into referencable accounts.

It should be noted, for the purposes of this invention, the term “customer” refers to an end-user of Information Technology (IT) services. Accordingly, the terms end-user and customer are used interchangeably herein. An “IT service” is one or a collection of application programs or computing resources (e.g. networks, servers) that in the aggregate provides a business function to a population of users. A “peer group” is a group of similarly situated users where each group is typically defined with respect to each IT service.

Currently, in regard to typical IT services and their respective providers, the following common problems arise related to customer satisfaction and end-user productivity with respect handling problems with the IT services. For example, currently customer satisfaction issues are identified by conducting qualitative surveys solicited from the IT population on a periodic basis, for example once per year. The qualitative answers and any “write-in” comments are then analyzed to identify issues with the IT services. There is no known solution that automates identification of potential customer satisfaction issues with quantitative near-real-time data. Additionally, the current state-of-the-art for collecting availability and performance data includes using a relatively small number of dedicated performance “probes” deployed at various locations within the IT infrastructure. Accordingly, because these probes are placed at various, and sometimes random, locations, they do not fully reflect the customer experience across the full customer population.

Another recognized problem with related art methods is that there is no known solution that allows customers to compare their experience using IT services with their peers. When a customer perceives that they have a performance problem with an IT service they often contact their peers to determine whether the problem is specific to their particular site or if it is widespread. Such a method, however, is an inefficient, ad-hoc and unstructured process that likely will not return useful data.

Yet another problem with current related art methods is that multiple users of IT services normally report the same problem to service centers/help desks. This often occurs because no automated solution exists for informing a specific group of users that a problem has already been identified and reported. Such duplication of efforts reduces end-user productivity and increases customer frustration with respect to the IT services and, as a result, negatively impacts customer satisfaction and increases the support cost due to handling of multiple calls.

Some related art methods have been proposed in an attempt to address at least one of the above described issues. For example, Internet performance checkers, such as those provided by Bandwidth Place of Calgary, Alberta Canada, provide a means for an end-user to request a throughput test from their computer to the server of the particular Internet performance checking service. After the checker is run, the results are displayed on the user's computer and compared to others in the same state. However, this approach is restricted to network performance only and there is no automatic action taken based on the results. Additionally, there is no concept of linkage to a customer satisfaction management process.

Other related art methods, known as web site “user experience” measurement tools/services, such as IBM's Surfaid Analytics product and website analysis products offered by Keylime Software, Inc. of San Diego Calif., are focused on capturing web site users' navigation paths on the web site. The collected data is then targeted for use by the providers of the web site to better understand usage trends and customer reaction to their web site content. This category of user experience measurement tools is applicable specifically to the Internet and intranet web site environment only. That is, they do not contemplate end-user peer group performance and there is no automatic action taken based on the results of the measurements to optimize or correct an end-user experienced performance problem. Additionally, there is no linkage to a customer satisfaction management process.

Another related art method, known as “adaptive probing,” developed by IBM, is focused on automated problem determination in a network-based computing environment. The method includes taking performance measurements from probe workstations and making decisions regarding which test transactions to run and which target systems to direct the transactions to, dependent upon the measurement results obtained in the probe workstation. The desired result is to determine the identity of the failing system component. In accordance with the adaptive probing technique, however, there is no facility to feed back the results of these measurements or actions to an end-user. Further, there is no concept of end-user peer group performance, and no linkage to a customer satisfaction management process.

### III. SUMMARY OF THE INVENTION

Illustrative, non-limiting embodiments of the present invention may overcome the aforementioned and other disadvantages associated with related art methods for measuring IT service customer satisfaction. Also, it is noted that the present invention is not necessarily required to overcome the disadvantages described above.

One exemplary embodiment of the invention comprises initiating a performance measurement for an end-user computer, executing a performance evaluation program, wherein the evaluation program exercises at least one service provided by the IT service, determining whether a potential customer satisfaction issue exists relative to the IT service based on a result of executing the performance evaluation program and reporting the potential customer satisfaction issue, if one exists, to at least one of a user of the end-user computer and a peer group including the user. Systems including devices or means for carrying out the functionality of the exemplary embodiment mentioned above are also well within the scope of the invention.

Another exemplary embodiment of the invention includes a computer program product for evaluating an IT service where the program product comprises a computer readable medium with first program instruction means for instructing a processor to issue a test transaction from the end-user computer to a target IT service, second program instruction means for instructing the processor to receive a respective transaction response corresponding to the test transaction from the IT service and third program instruction means for instructing the processor to determine a performance test result corresponding to an amount of time elapsed between the issuance of the test transaction and the receipt of the respective transaction response.

As used herein “substantially”, “generally”, and other words of degree, are used as a relative modifier intended to indicate permissible variation from the characteristic so modified. It is not intended to be limited to the absolute value or characteristic which it modifies but rather approaching or approximating such a physical or functional characteristic.

### IV. BRIEF DESCRIPTION OF THE DRAWINGS

The aspects of the present invention will become more readily apparent by describing in detail illustrative, non-limiting embodiments thereof with reference to the accompanying drawings, in which:

FIG. 1 is an flow diagram illustrating one embodiment of a method in accordance with the present invention.

FIGS. 2A-2G are each portions of a flow diagram illustrating an algorithm used in connection with one embodiment of a method in accordance with the present invention.

FIGS. 3A & 3B are exemplary illustrations depicting how end-user performance results and status information would be displayed to the end-user in accordance with an embodiment of the present invention.

FIG. 4 is a flow diagram illustrating an algorithm used in connection with one embodiment of a method in accordance with the present invention.

FIG. 5 is an illustration of how a customer satisfaction team would be notified in accordance with an embodiment of the present invention.

FIG. 6 is an illustration of a detailed “Action Taken” message in accordance with an embodiment of the present invention.

### V. DETAILED DESCRIPTION OF ILLUSTRATIVE, NON-LIMITING EMBODIMENTS

Exemplary, non-limiting, embodiments of the present invention are discussed in detail below. While specific configurations and process flows are discussed to provide a clear understanding, it should be understood that the disclosed process flows and configurations are provided for illustration purposes only. A person skilled in the relevant art will recognize that other process flows and configurations may be used without departing from the spirit and scope of the invention.

For purposes of clarity and focus on the main operational concepts of the invention, the description below does not address error or anomaly conditions that could potentially occur. Such anomalies merely detract from an understanding of the main flow concepts.

Six different components are provided in accordance with the invention. Non-limiting exemplary embodiments of the invention include at least one of the six components. The six components are mentioned here in no particular order. The first component is an automated method that is used to determine and report potential customer satisfaction issues for end-users and peer groups in regard to IT services. The method provides visibility for near-real-time availability and performance data from an end-user perspective and automates the identification of potential customer satisfaction issues.

Second, an automated method is provided for collecting performance and availability data experienced by computer users who access and run applications remotely via a network. This method uses a centralized application that automatically downloads and runs an evaluation program that “tests” performance and availability of specific applications from the end-user workstation. One of the unique features of this method is that it uses existing end-user workstations to collect the performance and availability data for the user. This method also minimizes the load on the infrastructure and applications by using already collected and current measurement data obtained from other users in the same peer group to satisfy requests to measure performance by a customer.

Third, a method is provided for organizing the availability and performance data by peer group based on a user profile, e.g., users' organizations, applications used, geographical location, job role, etc., and creates a peer group baseline based on actual availability and performance measurements. This baseline enables correlation between qualitative end-user IT satisfaction survey results and quantitative performance and availability measurements.

Fourth, a method is provided that enables an end-user to perform real-time performance and availability testing for remote application access from their workstation and compare the results against their peer group, e.g., within a similar geographic area, same or similar application accessed, job role, etc. This method enables the end-user to initiate the collection of measurements and understand how their experience compares with other users in their peer group.

Fifth, an automated method is provided for assessing performance and availability measurement data. Based on this assessment, it is possible to determine if a service delivery/helpdesk problem should be automatically reported on behalf of a particular end-user or peer group.

Sixth, a method is provided for communicating the status of problems and improving customer satisfaction with IT services. The method includes automatically informing an individual end-user or multiple end-users in a peer group, on a continual basis, about automated actions taken on their behalf.

As a result of implementing at least one of the individual methods mentioned above in accordance with the invention, certain business advantages are realized. These business advantages include shifting the IT customer satisfaction measurement data collection process from a qualitative survey-based process to an automated solution that provides quantitative customer satisfaction data in near-real-time. Additionally, it improves end-user customer satisfaction by empowering the end-user with near-real-time remote access performance and availability statistics for peer end-users. Further advantages that are realized are that end-user productivity is improved by reducing the time spent identifying and reporting problems and reducing the time necessary to identify remote access availability and performance problems. Lastly, implementing a method in accordance with the invention reduces workload. For example, call center/helpdesk activity is reduced.

Prior to describing detailed examples of illustrative embodiments of the invention, certain terms are defined for purposes of the disclosure.

For example, as mentioned above, an IT Service is one or a collection of application programs or IT computing resources, e.g., networks, servers, etc., that in the aggregate provide a business function to a population of users. Examples of IT Services are email, such as Lotus Notes developed by IBM; Instant Messaging, such as the Sametime application developed by IBM; and IBM intranet access to the W3 website, or an order entry system.

Peer groups are groupings of similarly situated end users with each peer group typically being associated with a specific IT service. Also, end users can belong to at least one peer group depending on the IT services they employ or, alternatively an end-user can belong to no peer groups. In table 1 below, examples of peer groups are provided as used in the IBM environment. The peer groups are defined as a set of attributes, origin, target and at least one demographic indicator.

TABLE 1

| | | | Demographic |
|---|---|---|---|
| IT Service | Origin | Target | Indicator(s) |
| Internet | Building | ibm.com | Job Role |
| | Location | | Organization |
| | Connection Point | | |
| | GEO | | |
| Intranet | Building | w3.ibm.com | Job Role |
| | Location | | Organization |
| | Connection Point | | |
| | GEO | | |
| eMail | Building | Mail Server | Job Role |
| | Location | | Organization |
| | Connection Point | | |
| | GEO | | |
| Instant | Building | Instant | Job Role |
| Messaging | Location | Messaging | Organization |
| | Connection Point | Server site | |
| | GEO | | |

For example, for the eMail service it is desired to collect and report measurement data associated with a particular location within a building located within a particular geographic area. The target for the peer group is the mail server that the mail file is hosted on. The demographic indicator is used to report data based on a particular job role and organization. This allows an organization to map customer satisfaction surveys to actual measurement data for a particular job role. An example is administrators who use eMail frequently to schedule meetings and check availability on calendars. Slow response times for the eMail IT service for administrators would typically result in poor customer satisfaction and reduced productivity.

For mobile users and users working from home, the “Connection Point” origin is used to identify where these users connect into the company network.

The capability to measure and report customer satisfaction within a peer group with similar job roles in a particular location is increasingly more important as companies drive towards delivering services targeted to specific user segments.

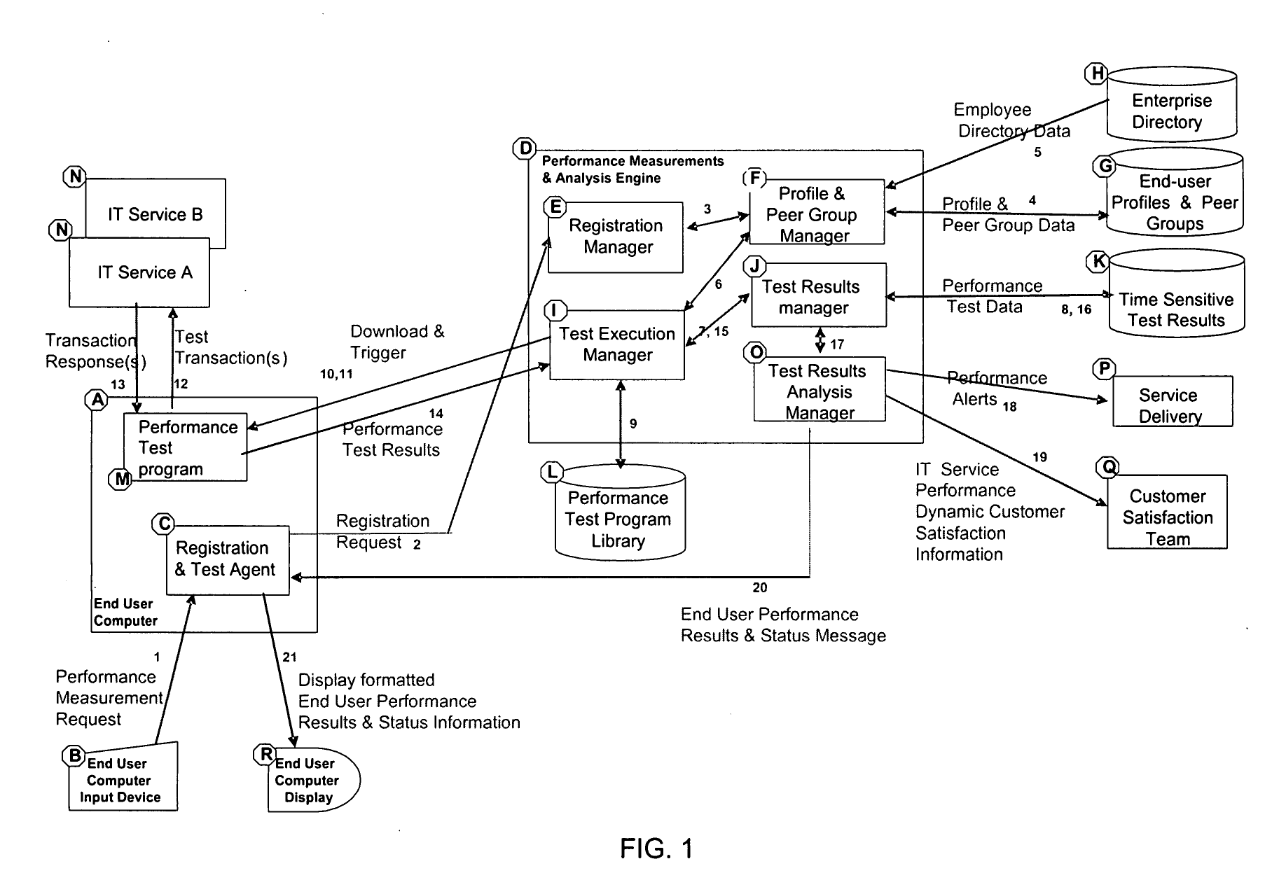

FIG. 1 illustrates exemplary components and information flows that comprise one exemplary method in accordance with the invention. In particular, FIG. 1 illustrates a new registration request for performance measurement from an end-user member of a peer group which does not have current relevant performance measurement data.

The process begins with an end-user indicating a desire to obtain a performance measurement by, for example, selecting an icon on the end-user Computer Display (R). The icon selected is, for example, a system tray icon on a windows-based system accessed via the end-user computer input device (B), such as the keyboard or mouse. Accordingly, the end-user has initiated a Performance Measurement Request (1). The end-user selection action causes the Registration & Test Agent (C) executing in an end-user computer (A) to send a Registration Request (2) to the Registration Manager component (E) of the central Performance Measurements and Analysis Engine (D). The Registration Request contains end-user computer profile data comprised of attributes that uniquely describe the specific end-user computer, e.g., end-user computer name, computer network identifier, etc.

The Registration Manager (E) makes a request (3) to the Profile & Peer Group Manager (F) to query (4) the End-User Profile and Peer Group database (G) to determine if this End-User computer and associated end-user already have a profile in the database. If they do not, i.e., this end-user and end-user computer have never previously registered, the Profile and Peer Group Manager (F) creates a profile for this end-user computer and end-user, fills in the fields of the profile with information passed in the registration request (2) and end-user information retrieved (5) from the Enterprise Directory (H), and writes the Profile record to the database (G).

After the profile has been created and stored, the Profile and Peer Group Manager (F) notifies (6) the Test Execution Manager (I) that an end-user computer has registered and is available to perform performance data collection as necessary. The Test Execution Manager now determines whether a current, e.g., based on the measurement lifetime length parameter, and relevant performance measurement exists for this end-user computer's peer group(s) by issuing a request (7) to the Test Results Manager (J). The Test Results Manager (J), in turn, sends the appropriate query or queries (8) to the Time Sensitive Test Results database (K). For the case where no current performance measurement data exists for this end-user computer—peer group combination, the Test Execution Manager then requests (9) the appropriate performance test program from the Performance Test Program Library (L) and sends (10) the performance test program (M) to the end-user computer (A). Upon successful Performance Test Program download verification from the Performance Test Program to the Test Execution Manager, the Test Execution Manager sends a trigger (11) to the Performance Test Program (M) to begin running its performance test(s).

The Performance Test program (M) issues test transaction(s) (12) to a target IT Service (N), e.g., Lotus Notes, and keeps track of the time it takes to receive the transaction response (13), i.e., performance test result, from the target IT service system. It should be noted that a “test transaction” as used in accordance with the present invention refers to a typical business transaction for which an end-user wishes to obtain performance information. That is, the present invention is not limited to specially formulated test transactions used uniquely for testing only, but rather uses selected real business transactions to perform the testing/analysis. The Performance Test program (M) then sends the performance test results (14) to the Test Execution Manager (I) which in turn issues a request (15) to the Test Results Manager (J) to validate the results and, if valid, to timestamp and store (16) the results in the Time Sensitive Test Results database (K).

Upon successful storage of a performance test result in the Time Sensitive Test Results database (K), the Test Results Manager (J) notifies (17) the Test Results Analysis Manager (O) that a measurement has been completed for the specific end-user computer (A) and the associated peer group(s). As part of this notification, the following parameters are passed from the Test Results Manager (J) to the Test Results Analysis Manager (O): an indication that this notification is associated with an actual measurement taken, the actual numeric measurement value to be returned to the end-user, the requesting end-user computer identification, and the identification of the peer group (previously associated with the end-user computer by an interaction between the Test Results Manager and the Profile and Peer Group Manager), and an indication of whether this is a measurement for a new end-user computer.

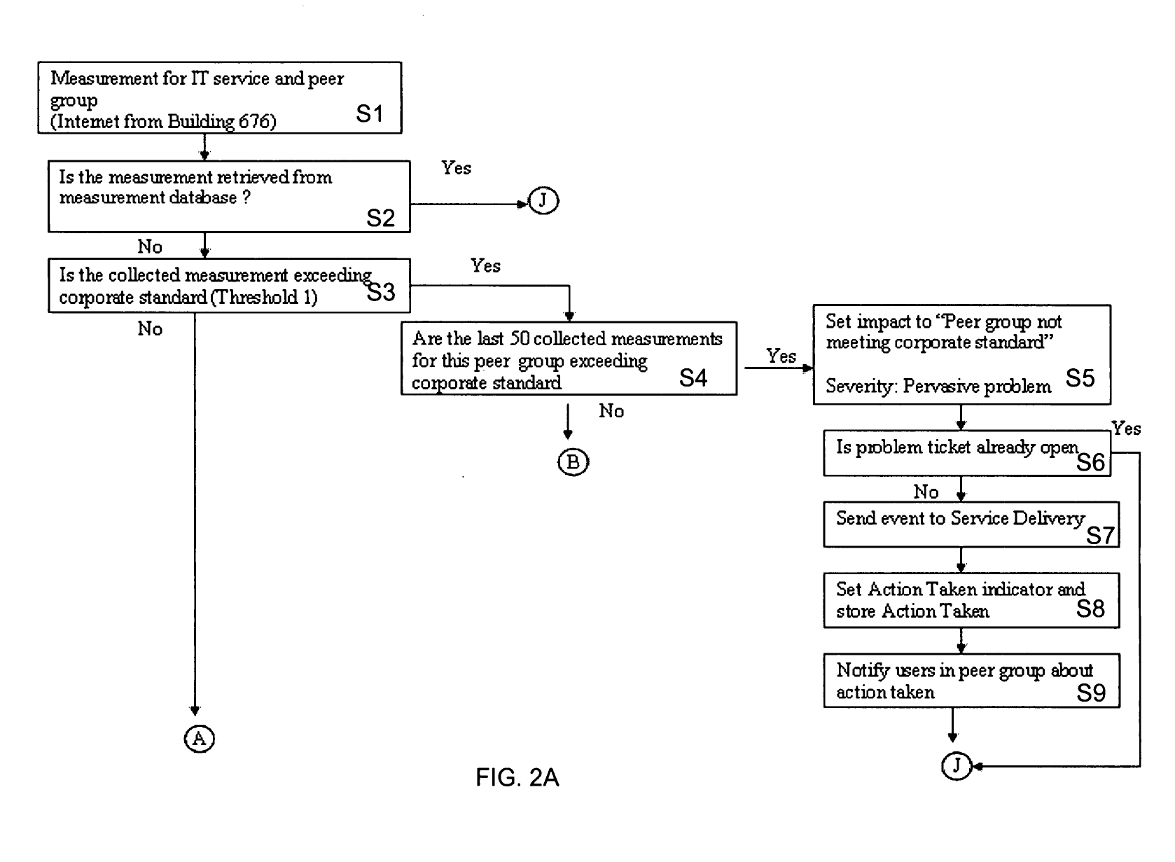

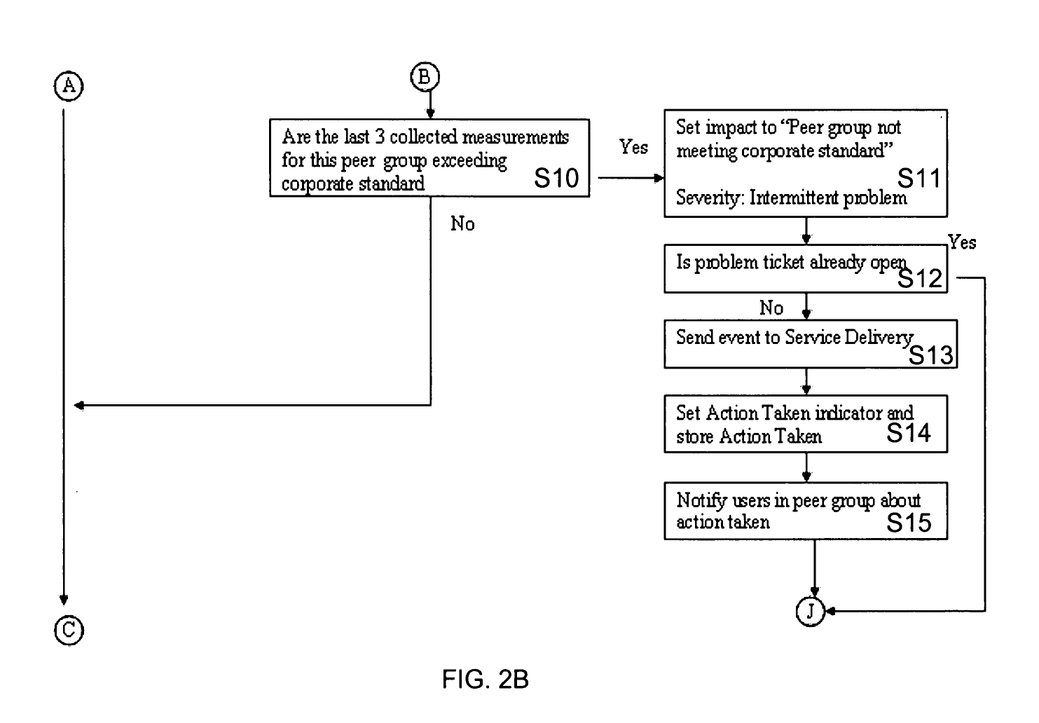

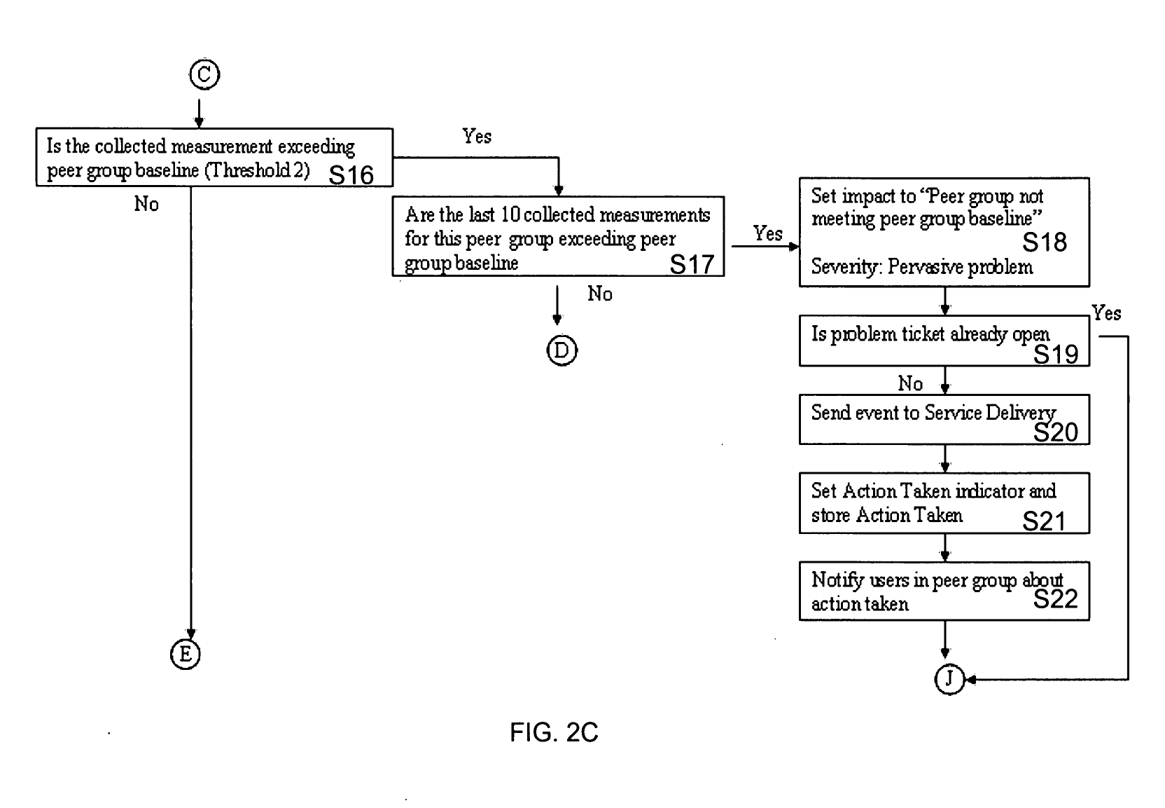

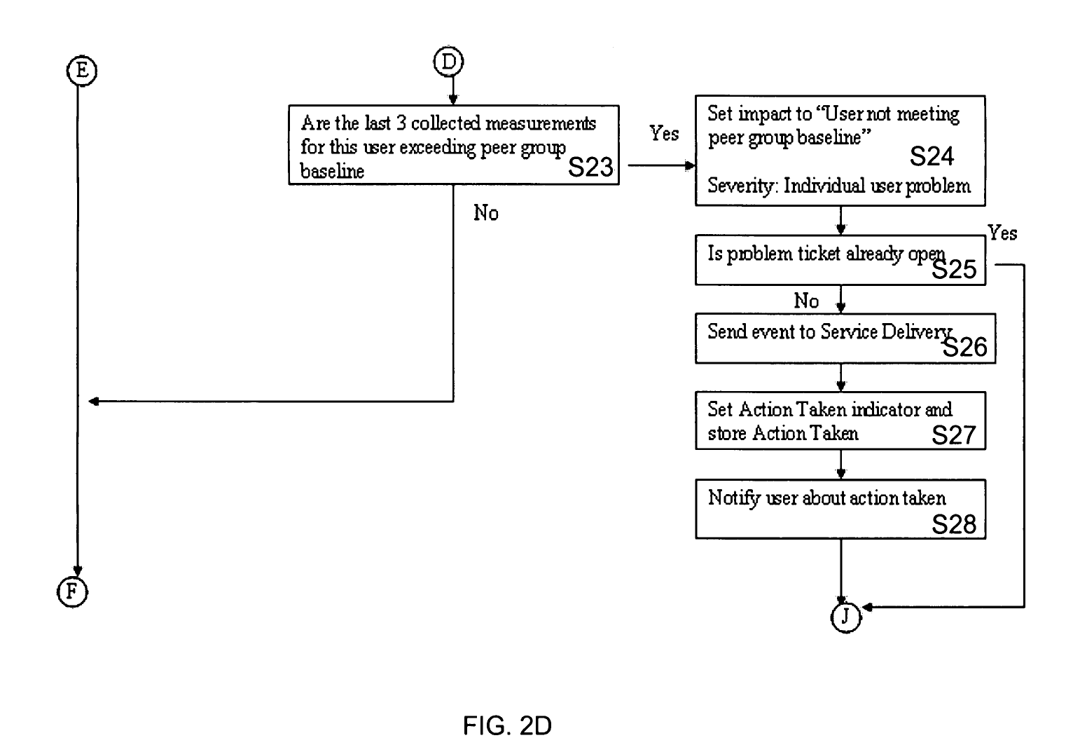

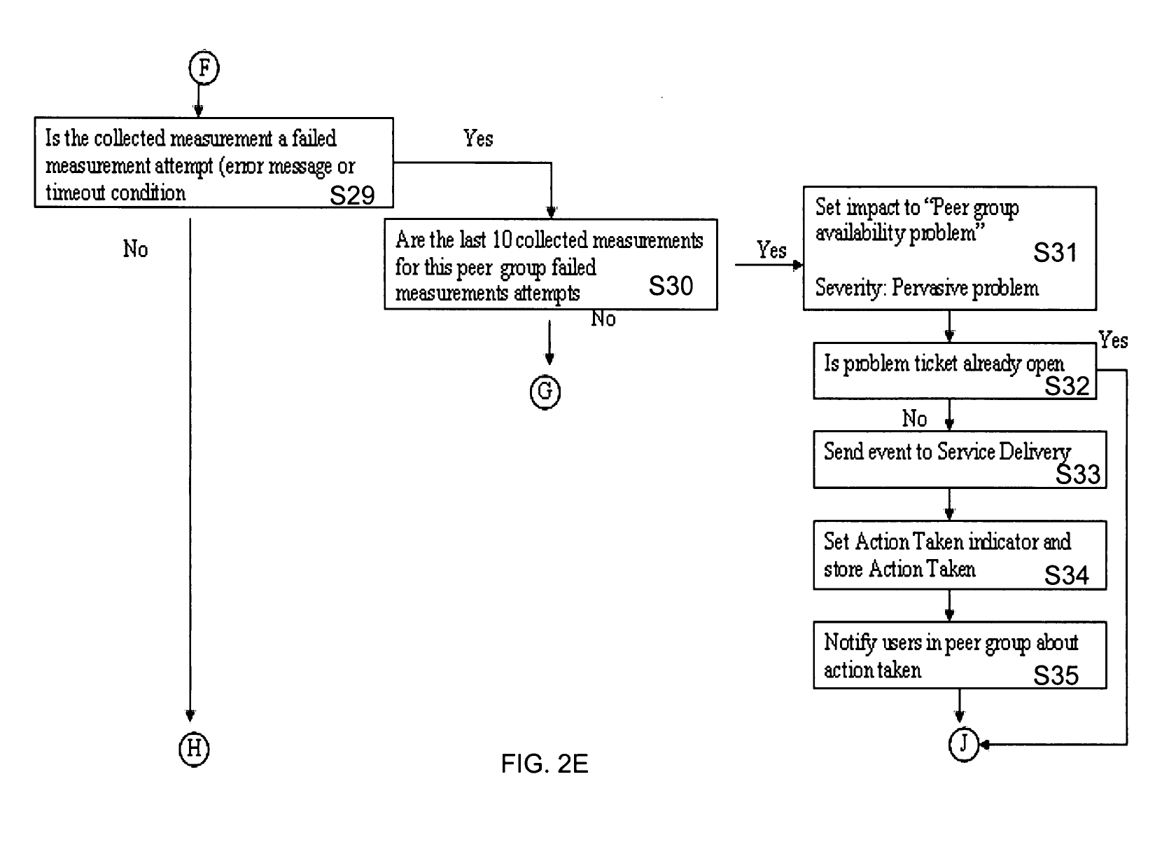

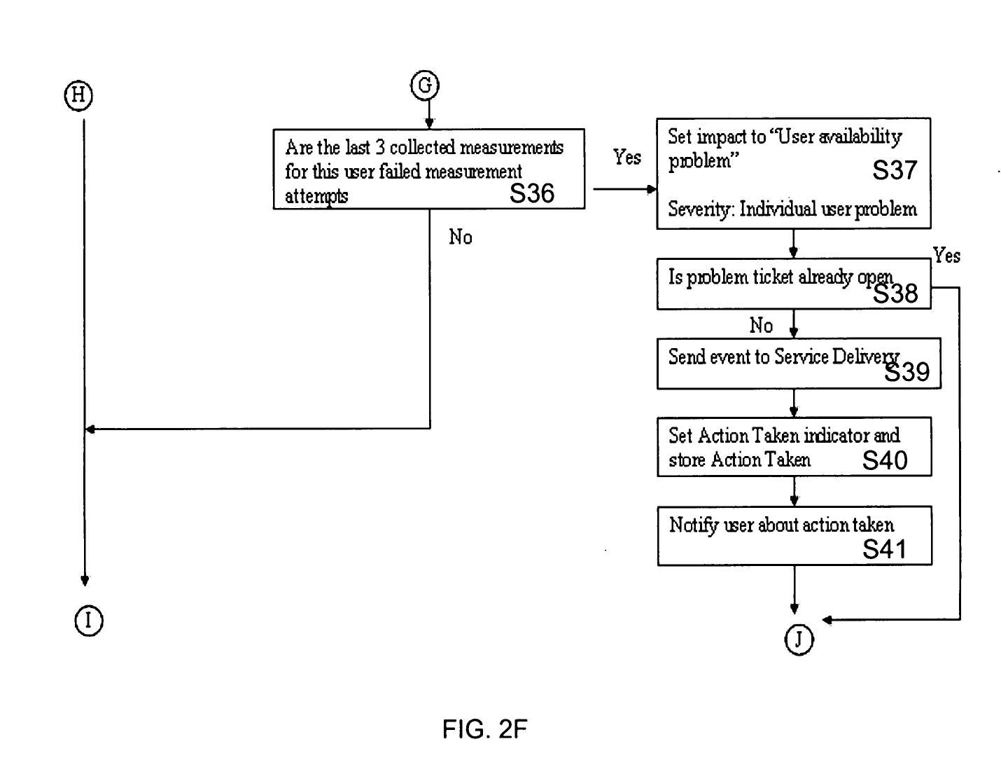

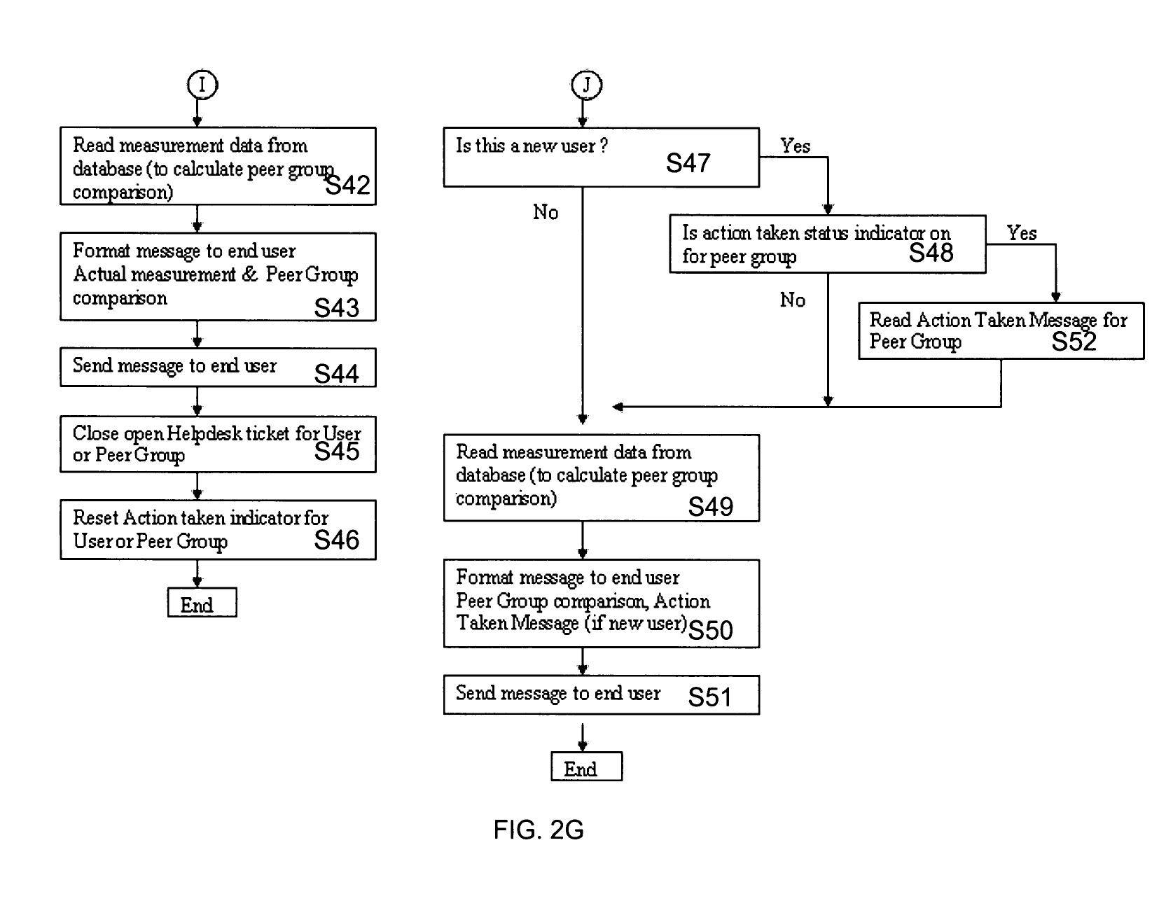

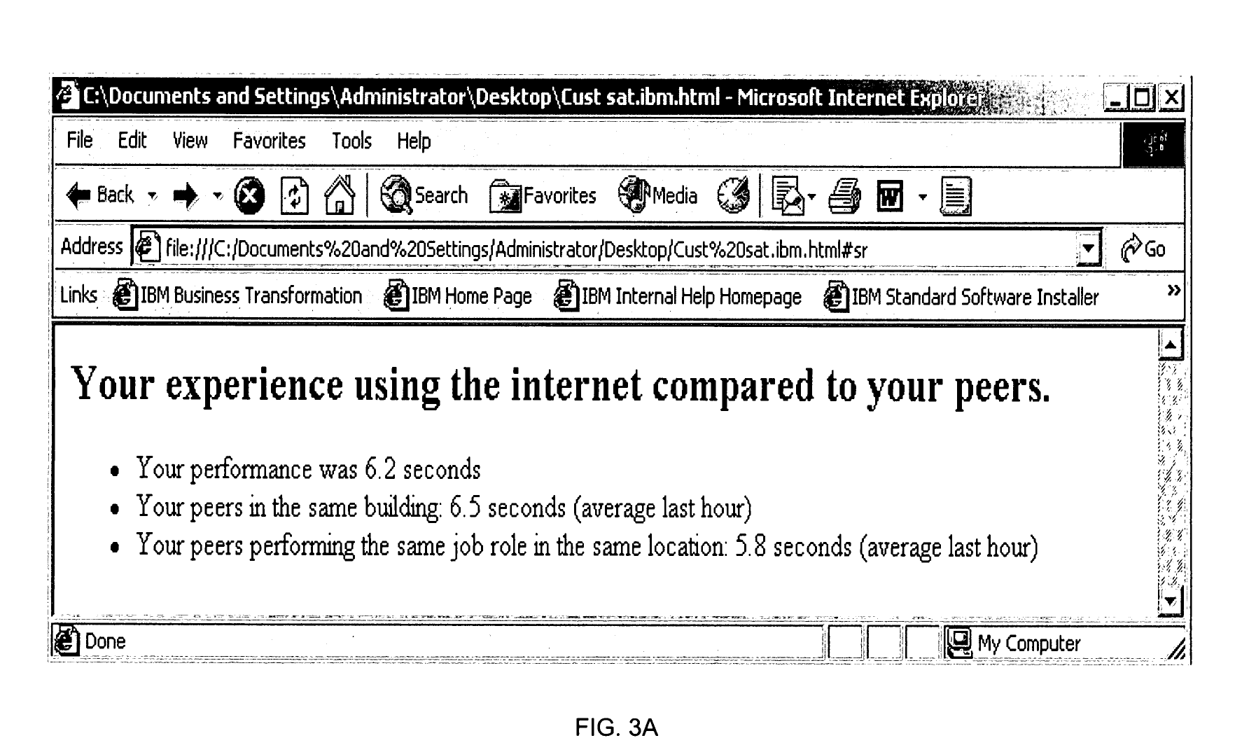

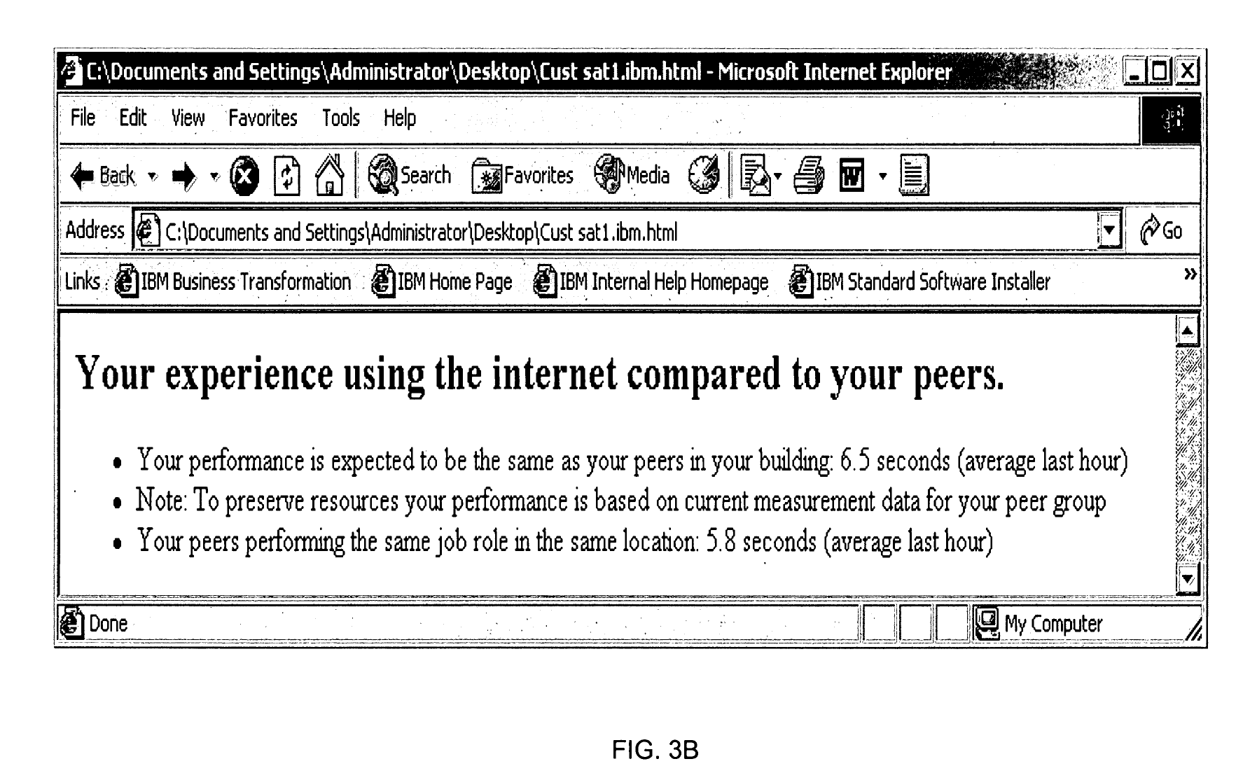

The Test Results Analysis Manager (O) then executes the “Performance Alert Analysis Algorithm,” as illustrated in FIGS. 2A-2G, to determine if the actual measurement value exceeds any of the performance thresholds, and if so, whether a Performance Alert (18) should be sent to the Service Delivery (P). (Establishment of the various performance thresholds and/or baselines is described in detail below.) Once this determination is made and the Performance Alert Notification is sent, if necessary, the Performance Alert Analysis Algorithm formats the measurement information passed to it by the Test Results Manager and sends the End-user Performance Results and Status (20) to the Registration & Test Agent (C) on the end-user computer(s) (A) which in turn displays the End-user Performance Results and Status (21) on the end-user computer display (R). An example of how the End-user Performance Results and Status information is displayed to end-user(s) is shown in FIG. 3A.

Accordingly, the above exemplary embodiment involves the situation where an end-user computer that is not previously registered requests a performance measurement where no current, e.g., time sensitive, and/or relevant, e.g., within the same peer group, measurement exists in the database.

The following description, referring again to FIG. 1, highlights aspects of a further embodiment of the present invention.

In particular, one issue related to most systems that automatically send test transactions to a production IT Service is the additional loading or workload that is placed on the IT Service computing system by the test transactions. One aspect of the present invention includes a method for controlling the additional test transaction loading placed on the production systems by associating a timestamp and a peer group with each performance measurement. As noted in the process flow in the embodiment described above, when an end-user computer requests a performance test, the Test Execution Manager (I) interacts with the Test Results Manager (J) to determine if a current relevant measurement already exists for the peer group to which the end-user computer belongs. If there is a current relevant measurement available in the database, no new measurement is obtained with respect to the specific requesting end-user computer. Under these circumstances, the most relevant current measurement is read from the Time Sensitive Test Results database (K).

Additionally, the Test Results Manager (J) notifies (17) the Test Results Analysis Manager (O) that an existing measurement should be returned to the requesting end-user computer. As part of this notification, at least one of the following parameters are passed from the Test Results Manager (J) to the Test Results Analysis Manager (O): an indication that this notification is associated with an existing measurement from the Time Sensitive Test Results database, the numeric measurement value to be returned to the end-user, the requesting end-user computer identification, and the identification of the peer group corresponding to the end-user computer associated with this measurement, an indication of whether this is a measurement for a new end-user computer.

The Test Results Analysis Manager (O) executes the “Performance Alert Analysis Algorithm,” discussed in detail below in reference to FIGS. 2A-2G, to send the End-user Performance Results and Status (20) to the Registration & Test Agent (C) on the requesting end-user computer (A) which in turn displays the End-user Performance Results and Status (21) on the end-user computer display (R). An example of how the End-user Performance Results and Status information is displayed to the end-user for the case where an existing measurement is returned is shown in FIG. 3B.

It should be noted that in accordance with at least one embodiment of the invention, the thresholds and peer group baselines are established for each end-user transaction or set of transactions, e.g., end-user scenario, because the measurement data must be evaluated over a period of time. There are several factors that make evaluation of the data difficult. Exceptions might occur due to changes in the infrastructure and application environment as well as such things as corporate governance of, for example, how much disk space end-user should use for their mail files, etc.

An exemplary method in accordance with this invention uses three different thresholds and baselines utilizing customer performance to determine when to send events and report out-of-range conditions. These thresholds are referred to as threshold1-threshold3 in the “Performance Alert Analysis Algorithm” and the “IT Service Performance Dynamic Customer Satisfaction Assessment Algorithm,” described below.

Threshold 1 is a threshold defined in a corporate standard. This threshold is used to ensure that employee productivity is not decreased by slow performance from supporting IT systems for internal systems. Threshold 1 can, for example, be used to protect the company brand when doing business with external customers.

Threshold 2 is a peer group baseline. That is, one of the unique functions of this invention is that it enables a dynamic peer group baseline to be calculated. This baseline, or threshold, can be established based on measurement data that records a performance level that the peer group normally experiences with an IT service. For example, this threshold can be determined using a 30 day rolling average.

Threshold 3 is defined as a variability threshold to identify situations where users in a peer group may experience variability in performance over a particular period of time, such as, a day.

Referring to FIGS. 2A-2G the Performance Alert Analysis Algorithm, mentioned above, is running in real-time when a measurement is received by the Test Results Analysis Manager (O). As shown in FIG. 2A, a measurement is requested (S1) and after it has been determined that the result is not retrieved from the database (S2), the measurement is compared to a corporate standard (S3). If the measurement exceeds the corporate standard, the algorithm checks if a large number of measurements, e.g., 50, for the peer group exceeded the corporate standard (S4). If so, the impact of the problem is set to “peer group not meeting corporate standard” and the severity is set to “pervasive problem” (S5). The impact and severity are used when determining the associated text and severity indication of the event being sent to service delivery.

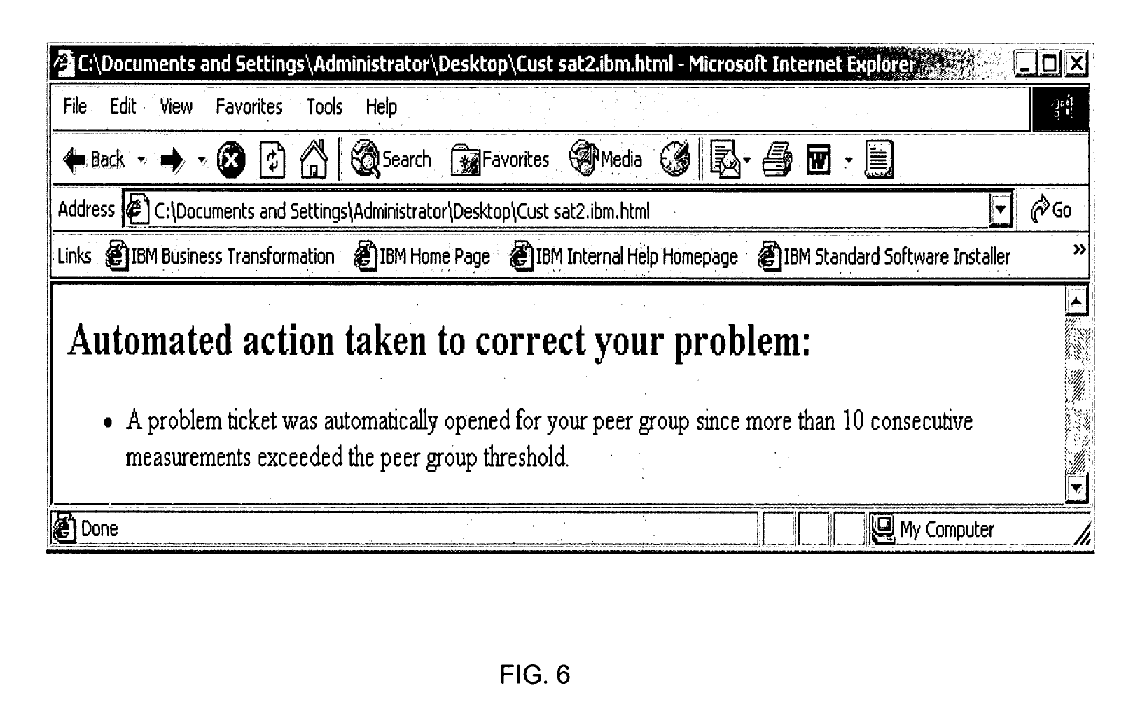

The algorithm then checks whether there is an open problem ticket (S6), i.e., an existing ticket identifying a particular problem, and if not, sends the event to Service Delivery (S7). The algorithm then sets the “action taken” status indicator which is used by the algorithm to determine that an action has been taken on behalf of a user or a peer group. Also, the detailed Action Taken message is stored in the database (S8). The users registered to the peer group are then notified about the action taken for the peer group (S9). For example, this notification uses an icon on the windows system tray to notify the users that an action has been taken and if selected a detailed “action taken” message will be displayed. An example of a detailed “Action Taken” message is shown in FIG. 6. In Windows-based systems, an alternative approach to presenting the action taken message to peer group members consistent with the invention is using a Windows system tray icon.

In accordance with the present invention, events such as performance alert notifications are generated for operations such as a helpdesk and/or service delivery. In accordance with one embodiment, the IBM Tivoli Enterprise Console tool is used for event handling. However, the present invention is not dependant on this particular tool; other event handling tools capable of receiving an event notification and presenting it to the service delivery operations staff for resolution can be implemented. For example, to implement the Performance Alert Analysis Algorithm basic commands, such as, the Tivoli “wpostemsg” or “postemsg” are used. To open a problem ticket, a wpostemsg with severity of WARNING could be issued with a message stating that Peer Group Threshold exceeded for Internet users in Building 676 in Raleigh:

wpostemsg, -r WARNING -m “Peer Group Threshold Exceeded for Internet users in building 676 in Raleigh.”

To close the same problem ticket, a wpostemsg with severity of HARMLESS could be issued:

wpostemsg, -r HARMLESS -m “Peer Group Threshold Exceeded for Internet users in building 676 in Raleigh.”

Referring to FIG. 2B, alternatively, if a smaller number of consecutive measurements, e.g., 3, exceed threshold 1, a different impact and severity will be set (S10). For example, the impact is similarly set to “peer group not meeting corporate standard,” but the severity is set to “intermittent problem” (S11). The algorithm checks if a problem ticket is already open (S12) and if not, sends an event to service delivery (S13). The action taken indicator is set and the “action taken” message is stored (S14). The users registered to the peer group are then notified about the action taken for the peer group (S15).

The threshold values as well as the number of consecutive measurements are all parameters that can be adjusted or tuned based on experience gained in applying this solution to a particular environment.

If, referring to FIG. 2A, the measurement does not exceed threshold 1, e.g., a corporate standard, the measurement is compared to the peer group baseline. The Test Results Analysis Manager (O) (FIG. 1) uses the peer group baseline to determine if a particular group of users experience performance problems compared to what they normally experience, for example, using a benchmark baseline. This is normally a lower threshold than the corporate standard.

Referring to FIG. 2C, the collected measurement is compared to the peer group baseline (S16) and if the measurement exceeds the peer group baseline the algorithm checks if the last 10 consecutive measurements for this peer group has exceeded the peer group baseline (S17). This comparison is used to filter intermittent errors that can occur in the environment. If the last 10 consecutive events exceeded the peer group baseline, the algorithm sets the impact to “Peer group not meeting peer group baseline,” sets the severity to “Pervasive problem” (S18) and then checks if a problem ticket is open (S19). If a problem ticket is not open, an event is sent to service delivery (S20). The action taken indicator is set and the action taken message is stored (S21). The users registered to the peer group are then notified about the action taken for the peer group (S22).

Referring to FIG. 2D, if the last 10 consecutive measurements did not exceed the peer group baseline (See FIG. 2C), the real-time algorithm checks the last three measurements for the particular workstation/user to determine whether either exceeded the peer group baseline (S23). If the last 3 measurements exceeded the peer group baseline, the algorithm sets the impact to “User not meeting peer group baseline,” sets the severity to “Individual user problem” (S24) and checks if a problem ticket is open (S25). If a problem ticket is not open, an event is sent to service delivery (S26). The action taken indicator is set and the action taken message is stored (S27). The user/workstation is notified that an action has been taken for this problem (S28).

As illustrated in FIG. 2E, the real-time algorithm also determines availability issues from an end-user perspective. If the collected measurement is a failed measurement attempt (S29), the algorithm checks if the last 10 consecutive measurements for the peer group failed (S30). If so, the algorithm sets the impact and severity parameters, accordingly, (S31) and checks if a problem ticket is open (S32) and, if not, sends an event to service delivery (S33). The action taken indicator is set and the action taken message is stored (S34). Users in the peer group are notified that the problem has been reported to service delivery (S35).

If, on the other hand, the last 10 consecutive measurements are not failed measurement attempts, as shown in FIG. 2F, the real time algorithm checks the last 3 measurements for the particular workstation/user to see if they are failed measurement attempts (S36). If the last 3 recorded measurements are failed measurement attempts, the algorithm sets the impact parameter to “user availability problem” and the severity to “individual user problem” (S37). The algorithm then checks if a problem ticket is open (S38) and if not sends an event to service delivery (S39). The action taken indicator is set and the action taken message is stored (S40). The user/workstation is notified that an action has been taken for this problem (S41).

If the collected measurement does not exceed threshold 1 (FIG. 2A) or threshold 2 (FIG. 2C) and the collected measurement is not a failed measurement attempt (FIG. 2E), referring to FIG. 2G, the required measurement data is read from the database to calculate peer group comparison (S42). The message to the user is formatted with the actual measurement and the calculated peer group comparison (S43). The message is sent to the user in response to the request from the user to do a performance test (S44). Because the actual measurement did not exceed any threshold, any open service delivery tickets for this workstation or peer group are closed (S45) and the action taken status indicator is reset (S46).

Still referring to FIG. 2G, if the collected measurement exceeded either threshold 1 or threshold 2 or if the measurement is a failed measurement from the database, the algorithm checks if this is a new user (S47). This check is performed to capture the situation where a user initiated a test and there was a current measurement in the database so no new measurement was collected in response to the request. If it is a new user, the algorithm checks whether the action taken status indicator is set for the peer group (S48) and if so reads the last action taken message (S52). If it is not a new user, the algorithm reads the required measurement data from the database to calculate peer group comparison (S49). The message to the user is formatted with the actual measurement and the calculated peer group comparison (S50) and, in this particular embodiment, the last action taken for the peer group is communicated to the user in response to a request from the user to do a performance test (S51).

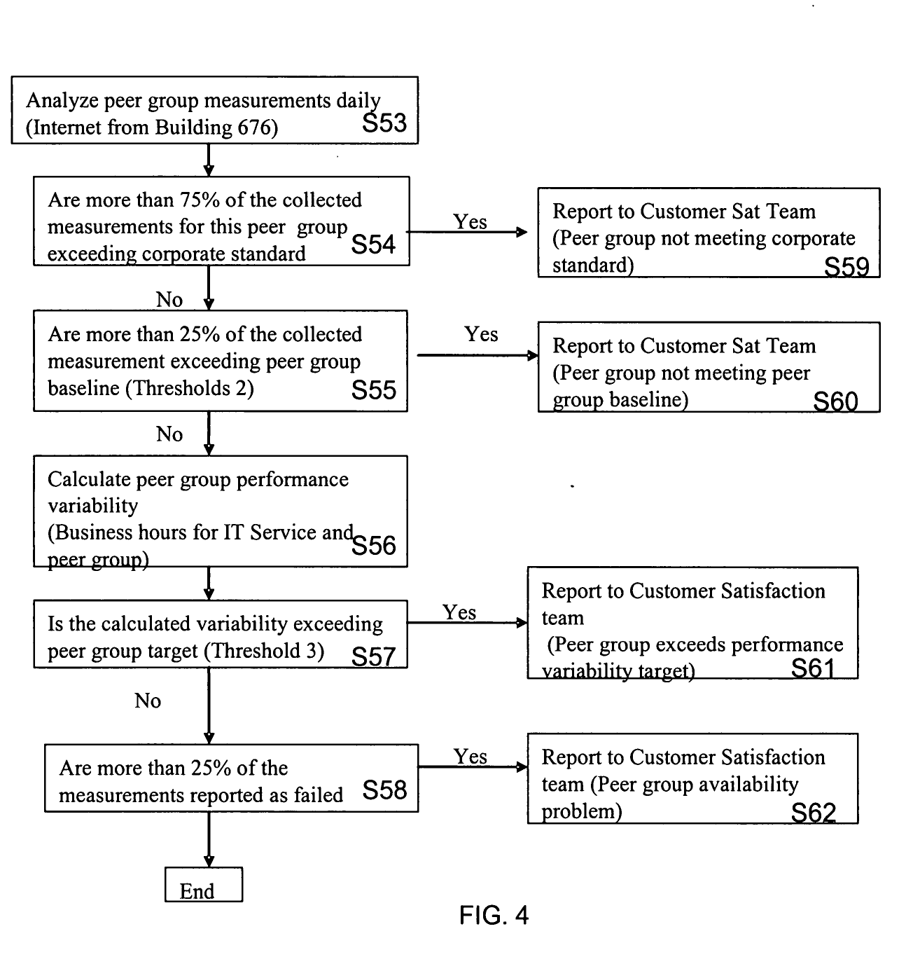

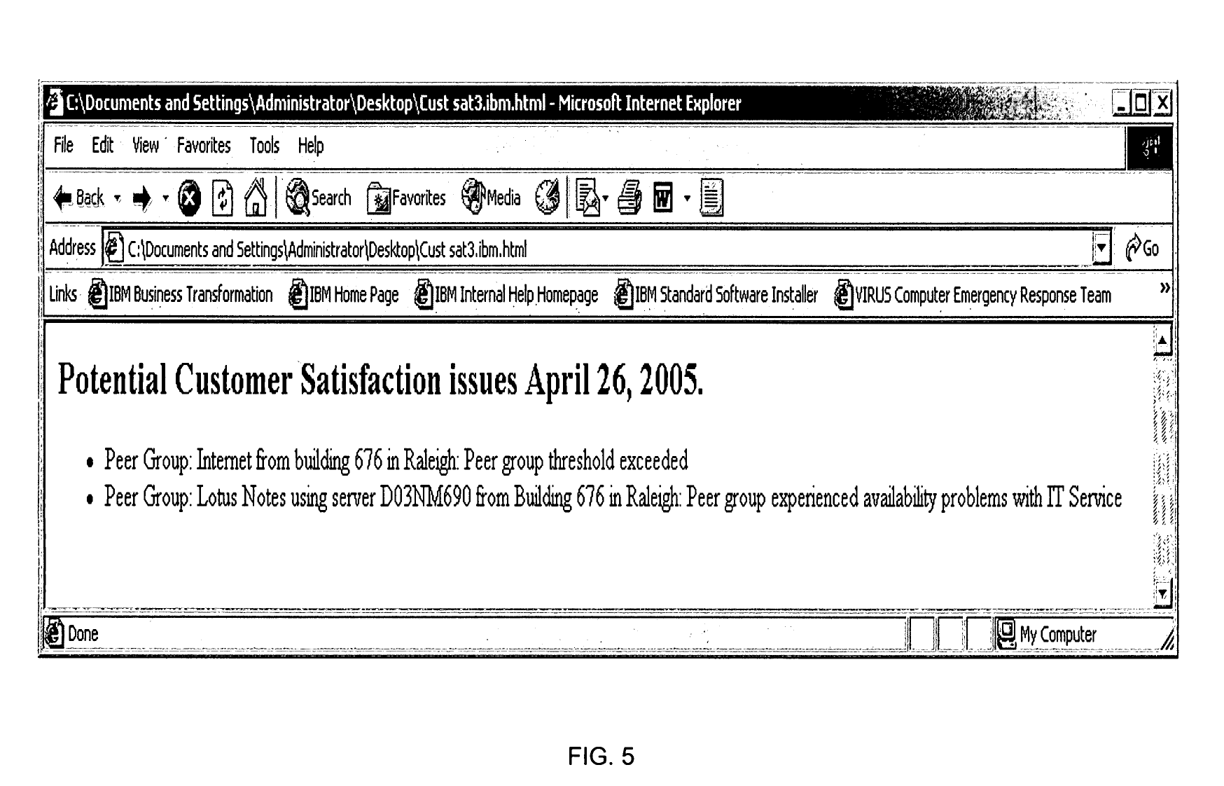

The Test Results Analysis Manager (0) (FIG. 1) is also responsible for executing the “IT Service Performance Dynamic Customer Satisfaction Assessment Algorithm,” which is illustrated in FIG. 4. The “IT Service Performance Dynamic Customer Satisfaction Assessment Algorithm” operates in the background in non-real-time and periodically, e.g., once per day or some other frequency set via a parameter, collects and aggregates end-user perspective IT Service performance trend information based on the employee demographic attributes that define the Peer Group(s). This algorithm is also capable of notifying the Customer Satisfaction team if negative performance trends are occurring that could impact Customer Satisfaction for a peer group of users. An example illustrating how the Customer Satisfaction team would be notified on a computer display device is shown in FIG. 5.

The IT Service Performance Dynamic Customer Satisfaction Assessment Algorithm can produce multiple reports to support customer satisfaction analysis. For instance, as shown in FIG. 5, two entries are provided indicating that the Internet peer group from building 676 in Raleigh experienced performance problems, indicating that the peer group baseline was exceeded. It also shows that the eMail peer group using a server (D03NM690) experienced availability problems with the eMail service.

Referring to FIG. 4, the IT Service Performance Dynamic Customer Satisfaction Assessment algorithm is run periodically, e.g., on a daily basis or some other frequency based on a set parameter, and produces a report to the customer satisfaction team (S53). One objective of this algorithm is to analyze performance and availability measurements to detect potential customer satisfaction issues with IT services as perceived by end users long before traditional survey methods would provide this insight. This algorithm also uses the peer group definitions described above for the analysis. The example provided is for Internet from building 676. Further, all of the thresholds can be dynamically modified.

If a particular percentage, for example 75%, of the daily measurements for a peer group exceed the corporate standard (S54), a report is generated to the customer satisfaction team (S59). If not, the algorithm checks if a certain percentage, e.g., 25%, of the daily measurements exceeds the peer group baseline (S55). If so, a report is generated to the customer satisfaction team indicating that the peer group is experiencing problems (S60) which will potentially impact customer satisfaction.

The algorithm calculates a variability value, e.g., the standard deviation, for business hours for the IT service (S56). The calculated value is then compared to threshold 3 (S57). If the calculated value exceeds threshold 3, such as a peer group target, a report is sent to the customer satisfaction team (S61) indicating that the peer group is experiencing variable response times which may impact customer satisfaction.

If the calculated value does not exceed threshold 3, the algorithm checks if a particular percentage, e.g., 25%, of the daily measurements were recorded as failed measurements (S58). If so, a report is generated to the customer satisfaction team (S62) indicating IT Service availability problems which may impact customer satisfaction.

While various aspects of the present invention have been particularly shown and described with reference to the exemplary, non-limiting, embodiments above, it will be understood by those skilled in the art that various additional aspects and embodiments may be contemplated without departing from the spirit and scope of the present invention.

For example, the invention can take the form of at least one of the following; an entirely hardware embodiment, an entirely software embodiment and an embodiment containing both hardware and software elements. In an exemplary embodiment, the invention is implemented in software, which includes but is not limited to firmware, resident software, microcode, etc.

Furthermore, the invention can take the form of a computer program product accessible from at least one of a computer-usable, computer-readable medium providing program code for use by or in connection with a computer and any instruction execution system. For the purposes of this description, a computer-usable or computer readable medium can be any apparatus that can contain, store, communicate, propagate, or transport the program for use by or in connection with the instruction execution system, apparatus, or device.

The medium can be at least one of electronic, magnetic, optical, electromagnetic, infrared and semiconductor system (or apparatus or device) and a propagation medium. Examples of a computer-readable medium include a semiconductor memory, a solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

It would be understood that a method incorporating any combination of the details mentioned above would fall within the scope of the present invention as determined based upon the claims below and any equivalents thereof.

Other aspects, objects and advantages of the present invention can be obtained from a study of the drawings, the disclosure and the appended claims.

What is claimed is:

1. A method for determining a performance value of an IT service, the method comprising:
initiating a performance measurement for an end-user computer;
sending a registration request from the end-user computer to a performance measurement and analysis engine, wherein the registration request comprises attributes that uniquely identify the end-user computer;
determining whether a profile for the end-user computer has been stored;
creating a profile comprising attributes that uniquely identify the end-user computer if no profile for the end-user computer has been stored;
determining whether a performance measurement result associated with the end-user computer for the initiated performance measurement has been stored;
sending a performance test program corresponding to the initiated performance measurement to the end-user computer if no performance measurement result associated with the end-user computer for the initiated performance measurement has been stored; and
executing the performance test program on the end-user computer.

2. A method as claimed in claim 1, further comprising:
issuing a test transaction from the end-user computer to a target IT service;
receiving a respective transaction response corresponding to the test transaction from the IT service; and
determining a performance test result corresponding to an amount of time elapsed between the issuance of the test transaction and the receipt of the respective transaction response.

3. A method as claimed in claim 2, further comprising:
sending the performance test result to the performance measurement and analysis engine;
validating the performance test result;
timestamping the performance test result; and
storing the timestamped performance test result.

4. The method as claimed in claim 3, further comprising sending a notification to the performance measurement and analysis engine indicating that a performance measurement has been completed, wherein the notification comprises, an indication that the notification is associated with an actual performance measurement taken in direct response to the initiated performance test, a measurement value and an identifier uniquely identifying the end-user computer.

5. A method as claimed in claim 2, further comprising:
determining whether the performance test result exceeds a first threshold;
if the performance test result exceeds the first threshold, determining whether a predetermined number of related performance test results, corresponding to a peer group to which the end-user computer is associated, exceeds the first threshold; and
if the performance test result does not exceed the first threshold, determining whether the predetermined number of related performance test results exceeds a second threshold.

6. A method as claimed in claim 1, further comprising:
issuing a test transaction from the end-user computer to a target IT service;
receiving a respective transaction response corresponding to the test transaction from the IT service;
determining a performance test result comprising an amount of time elapsed between the issuance of the test transaction and the receipt of the respective transaction response;
determining whether a first performance threshold has been exceeded by the performance test result.

7. A method as claimed in claim 6, further comprising:
if the first performance threshold has been exceeded by the performance test result, determining whether a plurality of peer group performance test results associated with a peer group of the end-user computer have exceeded the first performance threshold; and
if the plurality of peer group performance test results associated with a peer group of the end-user computer have exceeded the first performance threshold, determining whether a problem has been reported.

8. A method as claimed in claim 6, further comprising:
if the first performance threshold has not been exceeded by the performance test result, determining whether a second performance threshold has been exceeded by the performance test result; and
if the second performance threshold has not been exceeded by the performance test result, determining whether the performance test result is a failed test result.

9. A method as claimed in claim 1, further comprising indicating a predicted result corresponding to the initiated performance measurement if a performance measurement result associated with the end-user computer for the initiated performance measurement has been stored.

10. A system for evaluating an IT service, the system comprising:
means for initiating a performance measurement for an end-user computer;
means for sending a registration request from the end-user computer to a performance measurement and analysis engine;
means for determining whether a profile for the end-user computer has been stored;
means for creating a profile comprising the attributes that uniquely identify the end-user computer if no profile for the end-user computer has been stored;
means for determining whether a performance measurement result associated with the end-user computer for the initiated performance measurement has been stored;
means for sending a performance test program corresponding to the initiated performance measurement to the end-user computer if no performance measurement result associated with the end-user computer for the initiated performance measurement has been stored; and
means for executing the performance test program on the end-user computer.

11. A system as claimed in claim 10, further comprising:
means for issuing a test transaction from the end-user computer to a target IT service;
means for receiving a respective transaction response corresponding to the test transaction from the IT service; and
means for determining a performance test result corresponding to an amount of time elapsed between the issuance of the test transaction and the receipt of the respective transaction response.

12. A system as claimed in claim 11, further comprising:
means for determining whether the performance test result exceeds a first threshold;
means for determining whether the performance test result exceeds the first threshold;
means for determining whether a predetermined number of related performance test results, corresponding to a peer group to which the end-user computer is associated, exceeds the first threshold;
means for determining whether the performance test result does not exceed the first threshold; and
means for determining whether the predetermined number of related performance test results exceeds a second threshold.

13. A computer program product for evaluating an IT service, the program product comprising:
a computer readable medium;
first program instruction means for instructing a processor to issue a test transaction from the end-user computer to a target IT service;
second program instruction means for instructing the processor to receive a respective transaction response corresponding to the test transaction from the IT service; and
third program instruction means for instructing the processor to determine a performance test result corresponding to an amount of time elapsed between the issuance of the test transaction and the receipt of the respective transaction response.

14. A computer program product as claimed in claim 13, the program product further comprising:
fourth program instruction means for instructing the processor to compare the performance test result to a stored threshold;
fifth program instruction means for instructing the processor to determine if a problem has been reported;
sixth program instruction means for instructing the processor to request remedial action if the problem has not been reported.

15. A computer program product as claimed in claim 13, the program product further comprising:
seventh program instruction means for instructing the processor to send a registration request from the end-user computer to a performance measurement and analysis engine;
eighth program instruction means for instructing the processor to determine whether a profile for the end-user computer has been stored;
ninth program instruction means for instructing the processor to create a profile comprising attributes that uniquely identify the end-user computer if no profile for the end-user computer has been stored;
tenth program instruction means for instructing the processor to determine whether a performance measurement result associated with the end-user computer for the initiated performance measurement has been stored;
eleventh program instruction means for instructing the processor to send a performance test program corresponding to the initiated performance measurement to the end-user computer if no performance measurement result associated with the end-user computer for the initiated performance measurement has been stored; and
twelfth program instruction means for instructing the processor to execute the performance test program on the end-user computer.

16. A method for determining a performance value of an IT service, the method comprising:
initiating a performance measurement for an end-user computer;
executing a performance evaluation program, wherein the evaluation program exercises at least one service provided by the IT service;
determining whether a potential customer satisfaction issue exists relative to the IT service based on a result of said executing the performance evaluation program; and
reporting the potential customer satisfaction issue, if one exists, to at least one of a user of the end-user computer and a peer group including the user.

17. A method for determining a performance value of an IT service as recited in claim 16, the method further comprising:
downloading the performance evaluation program to the end-user computer, wherein the end-user computer is connected to a network;
collecting performance evaluation data relative to a plurality of end-user computers; and
incorporating the collected performance evaluation data relative to the plurality of end-user computers in said reporting of the potential customer satisfaction issue.

18. A method for determining a performance value of an IT service as recited in claim 16, the method further comprising:
organizing at least one of availability and performance data relative to end-user computers corresponding to members of the peer group;
creating a peer-group baseline based on actual measurements of at least one of availability and performance data corresponding to the end-user computers of the peer group;
collecting qualitative survey results from the members of the peer group; and
correlating the qualitative survey results to the at least one of availability and performance data relative to end-user computers.

19. A method for determining a performance value of an IT service as recited in claim 16, the method further comprising:
comparing results of the performance evaluation program for the end-user computer to peer-group results, wherein the peer-group results comprise at least one of performance and availability data of the peer group.

20. A method for determining a performance value of an IT service as recited in claim 16, the method further comprising:
determining whether the potential customer satisfaction issue has been reported on behalf of the end-user computer; and
informing at least one user of respective end-user computers of automated actions taken on their behalf.
